(19) United States
(12) Patent Application Publication
(10) Pub. No.: US 2004/0054757 A1
(43) Pub. Date: Mar. 18, 2004

(54) System for remote control of computer resources from embedded handheld devices

(76) Inventors: Akinobu Ueda, Santa Clara, CA (US); Tariq Mustafa, Fremont, CA (US); Uday Probhune, San Jose, CA (US)

Correspondence Address: Daniel D. Tagliaferri, Coudert Brothers, LLP, Third Floor, 600 Beach St., San Francisco, CA, 94109, US

(21) Appl. No.: 10/244,104

(22) Filed: Sep. 14, 2002

(51) Int. Cl. G06F 15/16

(52) U.S. Cl. 709/219

(57) ABSTRACT

Method for providing remote control of computer resources. The method allows a handheld device having an embedded operating system to remotely control one or more resources associated with a personal computer. The handheld device includes an interface to establish a communication channel with the personal computer. The method comprises steps of establishing a partnership between the handheld device and the personal computer using the communication channel, and sending a request from the handheld device to the personal computer using the communication channel, wherein the request is a request to control a selected resource associated with the personal computer.

### FIELD OF THE INVENTION

The present invention relates generally to computer systems, and more particularly, to a system for peer-to-peer network computing for a handheld device that allows the device to control remote computer resources.

### BACKGROUND OF THE INVENTION

Consumers desire portable lightweight devices that are easy to carry and use, such as Personal Digital Assistants (PDAs). However, a traditional PDA is typically used just as an organizer to provide synchronization of calendar tasks, address book, files and emails. Putting the device in a cradle that is connected to a desktop computer activates a synchronization process so that a user can exchange information with the desktop computer. In this configuration, the PDA plays a subordinate role to the desktop computer, since the user generally operates the computer to control the functions and data of the PDA. Subsequent generations of PDAs are more powerful because they include more powerful processors and built-in wireless connectivity. However, even though PDAs are becoming more powerful, their small size limits their capabilities to be less than that of desktop systems.

A typical method for remote networking is a system operated according to a server-client model. In this configuration, user authentication takes place by a domain server, and usually an administrator of the network takes care of the management of all users in the network. Thus, if a new user wants to be a network client, he has to ask the administrator to join the network. Such networks lack flexibility and do not allow for personal customization.

Handheld devices, such as PDAs, are restricted in terms of their computing capability due to their small footprint, low power, small memory, small display, small storage, and restricted input-output capability. Thus, these systems generally do not have the resources to become network clients, and so their functionality is limited to simple tasks (i.e., address book, to do lists) performed by users in a stand-alone mode. Thus, current system do not allow devices such as PDAs to have access to computer resources normally associated with large computer systems, such as network printers or storage devices.

Therefore, it would be desirable to have a way to provide a communication system that allows handheld devices, such as PDAs, to remotely control various computer resources associated with larger computer systems.

### SUMMARY OF THE INVENTION

The present invention includes a communication system for controlling various computer resources. For example, the system includes a method to remotely provide print instructions and data from a handheld device to a desktop computer, so that a user may control the desktop computer, and its printing resources, without having to be in the same physical location as the desktop computer. Thus, in one embodiment, the invention enables a handheld device, such as a PDA, to acquire new functionality by establishing a partnership with a larger computing device and controlling the resources associated with the larger device using a peer-to-peer network configuration. The resources include hardware resources, such as printers, disk drives, etc., and software resources, such as presentation programs, spread sheet programs or email programs.

A handheld device, like a PDA, includes an embedded operating system that has limited capabilities and/or functions. For example, computer resources that may be used in combination with larger computer systems may not be able to be used with a handheld device. For example, a printer device requires the use of a printer driver to control its functionality. The printer driver may be too large to be incorporated into a handheld device. Furthermore, the printer may require a special interface cable that cannot be attached to a handheld device because of the small size of the device. As a result, the handheld device cannot interface to the printer to print documents. However, in accordance with the invention, a handheld device with an embedded operating system may control the resources of a larger computer system, so that devices, like a printer, can be accessed and used under the control of the handheld device.

In one or more embodiments of the invention, user authentication takes place under the control of the owner of the handheld and desktop computer devices. This enables the creation of easy to use ad-hoc personal networks, because the intervention of a system administrator is not necessary. In addition, users can optimize the use of computer resources since, the owner of the handheld device and personal computer can always use the same configuration, thereby providing a customized communication connection.

In one embodiment, the system allows a user to send commands from a remote PDA to a desktop personal computer (PC) using a peer-to-peer network. During operation, the user controls the PDA to send commands and data to the PC, which then performs selected functions based on the received commands. Thus, the PDA and PC form a partnership, so that the PDA user can make use of the PC's resources without directly operating the PC. In one embodiment, the partnership between PDA and PC is established through wireless technology, such as through an 802.11b or Bluetooth wireless interface. Thus, a user can establish a partnership between a PDA and a remote desktop PC using Wireless Wide Area Network (WWAN) technology, and thereby form a virtual personal network. The desktop PC may also be connected to another computer network, whose resources would then be accessible to the PDA using the WWAN. For example, it is possible to use a PDA to control printing on a network printer that is accessible by a desktop PC.

In another embodiment included in the present invention, a method is provided for using a handheld device having an embedded operating system to remotely control one or more resources associated with a personal computer, wherein the handheld device includes an interface to establish a communication channel with the personal computer. The method comprises establishing a partnership between the handheld device and the personal computer using the communication channel, and sending a request from the handheld device to the personal computer using the communication channel, wherein the request is a request to control a selected resource associated with the personal computer.

In another embodiment included in the present invention, a handheld device provides remote control of computer resources associated with a personal computer. The handheld device includes an interface to establish a communication channel with the personal computer, and the handheld device comprises logic to establish a partnership between the handheld device and the personal computer using the communication channel, and logic to send a request from the handheld device to the personal computer using the communication channel, wherein the request is a request to control a selected resource associated with the personal computer.

In another embodiment included in the present invention, a personal computer device having associated computer resources is provided. The personal computer includes a communication channel with a handheld device that operates to control the computer resources. The personal computer comprises logic to establish a partnership between the handheld device and the personal computer using the communication channel, and logic to receive a request from the handheld device using the communication channel, wherein the request is a request to control a selected computer resource associated with the personal computer.

In another embodiment included in the present invention, a computer software product is provided that includes a medium readable by a processor in a handheld device. The medium having stored thereon a first sequence of instructions which, when executed by said processor, causes said handheld device to establish a partnership between the handheld device and a personal computer using a communication channel. The medium also having stored thereon a second sequence of instructions which, when executed by said processor, causes said handheld device to send a request to the personal computer using the communication channel, wherein the request is a request to control a selected resource associated with the personal computer.

In another embodiment included in the present invention, a computer data signal embodied in a carrier wave is provided that comprises a first source code segment comprising one or more sequences of instructions, which when executed by a processor included in a handheld device, causes said handheld device to establish a partnership between the handheld device and a personal computer using a communication channel. The computer data signal also comprises a second source code segment comprising one or more sequences of instructions, which when executed by the processor included in the handheld device, causes said handheld device to send a request to the personal computer using the communication channel, wherein the request is a request to control a selected resource associated with the personal computer.

### BRIEF DESCRIPTION OF THE DRAWINGS

The foregoing aspects and the attendant advantages of this invention will become more readily apparent by reference to the following detailed description when taken in conjunction with the accompanying drawings wherein:

FIG. 1 shows a diagram of one embodiment of a peer-to-peer network computing for small footprint devices in accordance with the present invention;

FIG. 2 is a block diagram that illustrates one embodiment of a handheld device 200, for example a PDA, upon which an embodiment of the invention may be implemented;

FIG. 3 shows a diagram of software components used to establish a partnership between a handheld device and a PC in accordance with the present invention;

FIG. 4 shows one embodiment of a software architecture for providing remote control of computer resources in accordance with the present invention;

FIG. 5 shows a flow graph illustrating the operation of one embodiment of the invention, where the invention is embodied operating on a handheld device, such as a PDA;

FIG. 6 shows a flow graph illustrating the operation of one embodiment of the invention, where a portion of the invention is embodied operating on a personal computer, such as a desktop office computer; and

FIG. 7 shows an exemplary table of resources available on a PC and associated applications that may be remotely controlled in accordance with the present invention.

### DETAILED DESCRIPTION

The present invention includes a system for remote control of computer resources from a handheld device having an embedded operating system. For example, in one embodiment the system allows a remote handheld device, such as a PDA, to create a partnership with a desktop computer that allows the PDA to control computer resources available to the desktop computer. Thus, it is possible for the PDA to utilize a network printer accessible to the desktop computer. The following description describes how a system in accordance with the present invention allows a remote PDA to control resources associated with a desktop computer. The system is also suitable for partnering other types of portable handheld devices having embedded operating systems and having remote interface capability.

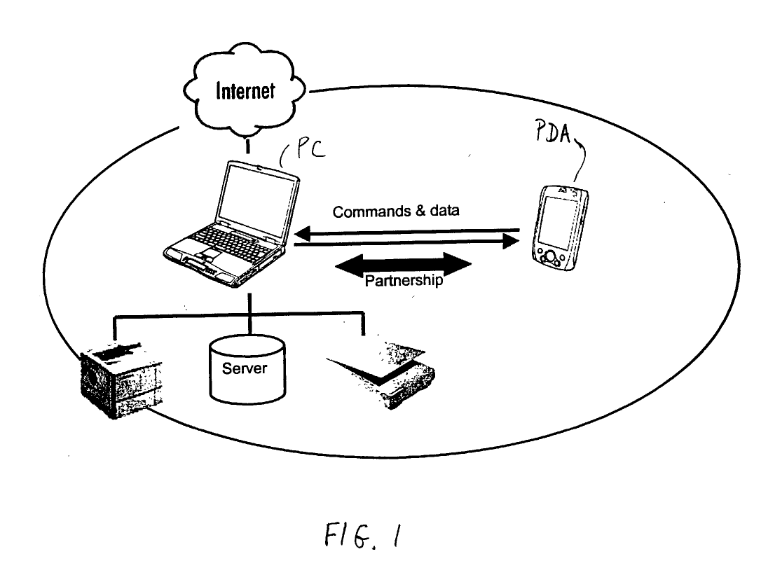

FIG. 1 shows a diagram of one embodiment of a peer-to-peer network comprising a handheld device and a personal computer in accordance with the present invention. In the peer-to-peer network of FIG. 1, the PDA and the PC form a partnership. The establishment of the partnership includes a device authentication process where the PC authenticates transmissions from the PDA. During operation of the partnership, the PC and PDA have the functionality to exchange commands and data that describe procedures based on the operation of the PDA. In addition, the PC and PDA have the functionality to analyze the commands and data, and perform operations associated with the commands. For example, a user may own both the PC and PDA, and set up the devices so that the PDA may control resources associated with the PC. Thus, the user may have the PC located in an office location, and while outside the office, control the resources available to the PC by using the PDA.

According to commands and data from the PDA, the PC operates to provide functions to the PDA that the PDA does not itself have. For example, resources available to the PC, such as printers and storage devices, can be controlled by the PDA. In addition, the status of the PC and its resources can be displayed on the PDA.

Furthermore, by adding new software components, (such as DLL components), new capabilities are available to the PDA. For example, the following functions associated with the PC can be made available to the PDA.

1. Control and Printing on local or networked printers

2. Presentation of PC information on PDA display

3. Playing of Audio / Video files on PDA (Audio / Video data is stored on the storage of the PC, transferred from the PC to the PDA, and played on the PDA).

4. Control of software applications running on PC by PDA.

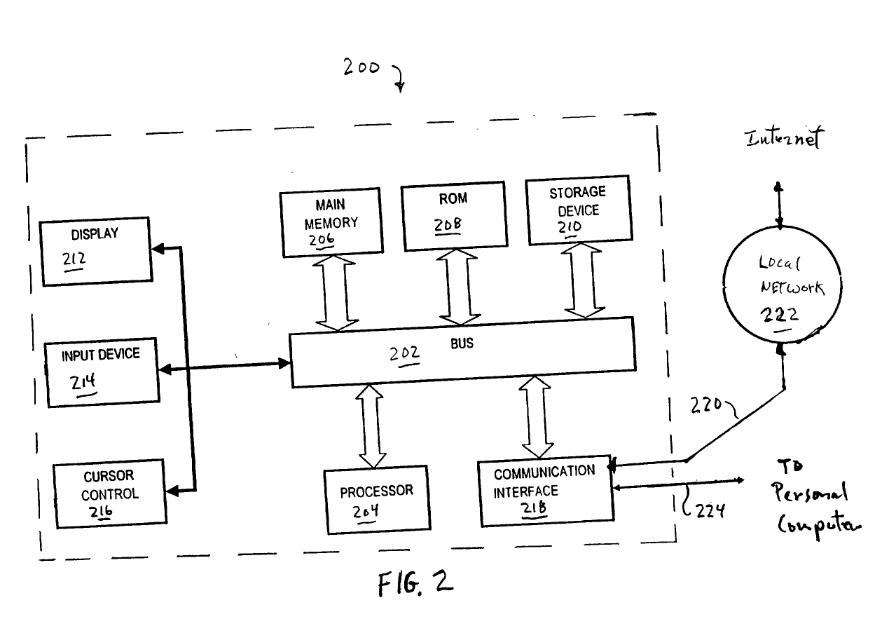

FIG. 2 is a block diagram that illustrates one embodiment of a handheld device 200 having an embedded operating system, for example a PDA, upon which an embodiment of the invention may be implemented. The device 200 includes a bus 202 or other communication mechanism for communicating information, and a processor 204 coupled with bus 202 for processing information. The device 200 also includes a main memory 206, such as a random access memory (RAM) or other dynamic storage device, coupled to bus 202 for storing information and instructions to be executed by processor 204. Main memory 206 also may be used for storing temporary variable or other intermediate information during execution of instructions to be executed by processor 204. The device 200 further includes a read only memory (ROM) 208 or other static storage device coupled to bus 202 for storing static information and instructions for processor 204.

The device 200 may be coupled via bus 202 to a display 212, such as an LCD display, for displaying information to a device user. An input device 214, including alphanumeric and other keys, is coupled to bus 202 for communicating information and command selections to processor 204. Another type of user input device is cursor control 216, such as a touch pad or cursor direction keys for communicating direction information and command selections to processor 204 and for controlling cursor movement on display 212.

The invention is related to the use of the device 200 for controlling resources associated with a personal computer. According to one embodiment of the invention, controlling the resource of a personal computer is provided by device 200 in response to processor 204 executing one or more sequences of one or more instructions contained in one of the memories. Such instructions may be read into main memory 206 from another computer-readable medium, such as storage device 210. Execution of the sequences of instructions contained in one of the memories causes processor 204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 204 for execution. Such a medium may take many forms, including, but not limited to, non-volatile media, volatile media, and transmission media. Non-volatile media include, for example, optical or magnetic disks, or solid state storage, which may form storage device 210. Volatile media include dynamic memory, such as main memory 206. Transmission media include coaxial cables, copper wire, and fiber optics, including the wires that comprise bus 202. Transmission media can also take the form of acoustic or light waves, such as those generated during radio frequency (RF) and infrared (IR) data communications. Common forms of computer-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEPROM, any other memory chip or cartridge, a carrier wave as described hereinafter, or any other medium from which a computer can read.

Various forms of computer-readable media may be involved in carrying one or more sequences of one or more instructions to processor 204 for execution. For example, the instructions may initially be borne on a magnetic disk of a remote computer. The remote computer can load the instructions into its dynamic memory and send the instructions over a telephone line using a modem. A modem local to device 200 can receive the data on the telephone line and use an infrared transmitter to convert the data to an infrared signal. An infrared detector coupled to bus 202 can receive the data carried in the infrared signal and place the data on bus 202. Bus 202 carries the data to main memory 206, from which processor 204 retrieves and executes the instructions. The instructions received by main memory 206 may optionally be stored on storage device 210 either before or after execution by processor 204.

The device 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic, or optical signals that carry digital data streams representing various type of information.

Network link 220 typically provides data communication through one or more networks to other data devices. For example, network link 120 may provide a connection through local network 222 to a host computer or to data equipment operated by an Internet Service Provider (ISP). The ISP in turn provides data communication services through the worldwide packet data communication network, now commonly referred to as the “Internet.” Local network 222 and the Internet both use electrical, electromagnetic, or optical signals that carry digital data streams. The signals through the various networks and the signals on network link 220 and through communication interface 218, which carry the digital data to and from the device 200, are exemplary forms of carrier waves transporting the information.

The device 200 can send messages and receive data, including program codes, through the network(s), network link 220, and communication interface 218. In the Internet example, a server might transmit a requested code for an application program through the Internet, ISP, local network 222, and communication interface 218. In accordance with the invention, one such downloaded application allows the device 200 to control resources associated with a personal computer as described herein.

The received code may be executed by processor 204 as it is received, and/or stored in storage device 210, maim memory 206, or other non-volatile storage for later execution. In this manner, the device 200 may obtain an application code in the form of a carrier wave.

Communication interface 218 also provides a two-way data communication coupling 224 to a personal computer. In one embodiment, the communication creates a partnership between the device 200 and the personal computer in accordance with the present invention. For example, communication interface 218 may include logic to form a serial, USB, parallel, or modem link as communication coupling 224. As another example, communication interface 218 may also include logic to provide a wireless link, such as an 802.11b or Bluetooth link, as communication coupling 224. In any such implementation, communication interface 218 communicates with the personal computer using communication coupling 224 to send and receive electrical, electromagnetic, or optical signals that carry digital data streams representing various type of information.

Software Architecture

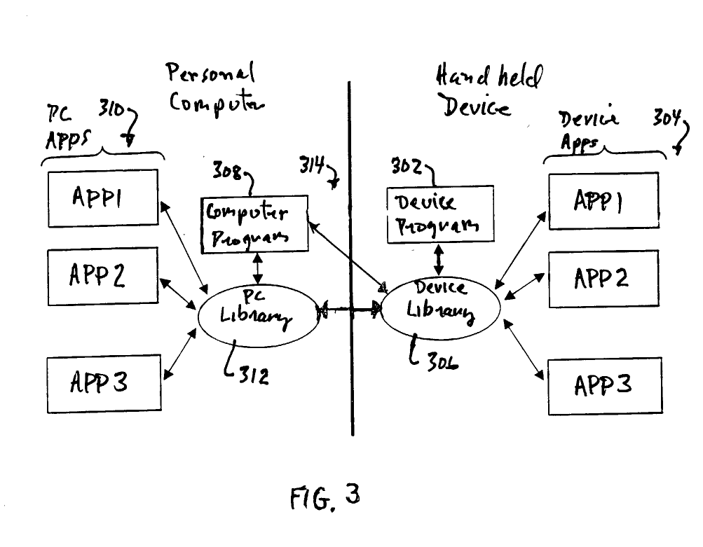

FIG. 3 shows a diagram of software components used to establish a partnership between a handheld device and a PC in accordance with the present invention. In the device, a device program 302 has the capability to execute one or more device applications 304 in conjunction with a device library 306. In the PC, a computer program 308 has the capability to execute one or more computer applications 310 in conjunction with a PC library 312.

During operation, the computer program 308 starts executing when a user logs-in. The program 308 hooks into a low level operating system communication stack (CMTL) and monitors the connection state. The CMTL provides hardware independent (wired, wireless, etc.) authentication and connection between the handheld device and the PC computer. When the program 308 detects that the CMTL connection is established, it communicates with the device library 306 and establishes a connection for application communication. The computer program 308 also communicates with the PC library 312 and initializes the connection.

The device program 302 also starts executing when the device is turned on. The program then monitors the CMTL connection status. When it detects loss of connection, it un-initialized the device library 306.

PC applications 310 and device applications 304 respectively, call into the PC library 312 and device library 306 to communicate with each other. The PC library 312 and device library 306 expose functions that applications can call to read and write commands and data to applications o the other side of the connection. This provides a robust mechanism for multiple applications on the PC and on the device to communicate with each other simultaneously.

The handheld device establishes a partnership with the PC as indicated in FIG. 3. The partnership allows the two devices to communication information to each other. For example, the PC may communicate locally stored documents to the handheld device. Alternatively, the handheld device may transmit control instructions to the PC. For example, the handheld device may transmit a control instruction to cause the PC to transmit the document or to print the document on one of its available printers. Thus, using the partnership, the resources controlled by the PC are accessible for use by the handheld device. The capability to remotely control the PC's resources greatly expands the functionality of the handheld device, since its capabilities may be too limited to control those resources on its own.

Example of Remote Control of Printing

In accordance with one or more embodiments included in the present invention, an example of remotely controlling document printing from a handheld device is provided as follows.

A proprietary email client, one of the handheld device applications 304, displays email, tasks, appointments and contacts. The email client hooks into a Message Store maintained by the device's embedded operating system (OS). The embedded OS takes care of synchronization of emails in the Message Store with the partnered PC computer. The proprietary client displays on the handheld device the contents (email, tasks, etc.) of the Message Store in a user-friendly manner. In addition to providing display of the Message Store contents, the client also supports printing of the contents. The following is a description of how the printing works for an email (a similar process is used with other Message Store contents.

The CMTL is defined as an OS component that has subcomponents on the PC as well as handheld device, which are responsible for authenticating and establishing hardware independent (wired, wireless etc) connection between PC and the handheld device.

In one embodiment included in the present invention, a data structure for application communication supported by the PC (#312) and Device Libraries (#306) is as follows:

{

Size of the message;
Application ID to which this message is to be sent;
Function ID (or command ID);
Unique message ID;
// Function or Command specific data follows here

}

Note that an application on either side (PC/Handheld) can send data to any application (supporting the command) on the other side—the application ID is embedded in the data structure above.

The Proprietary email client on the handheld device (one of the Device Apps 304) has a counter part on the computer—PC Email Client (one of the PC Apps 310). When CMTL connection is established, the PC Email Client enumerates the printers on the PC and sends the list of printers to the handheld Email Client. The generic data structure is as follows:

{

Size of the message;
Application ID to which this message is to be sent (handheld email client);
Function ID (or command ID) - Printer Enumeration;
Unique message ID;
// Function or Command specific data follows here
List of enumerated printers

}

Upon receiving the printer list, handheld maintains this list.

The handheld email application provides views of the Message Store data. For example, when a user views email, he has an option of printing the email. The email client provides the list of available printers on the PC. The user can select one of the printers and print the email.

When the user chooses to print the email, the email client generates a formatted document with email details such as Sender name, time, email content, etc., and saves the document on the handheld. Then it communicates all the printing details to the email client counterpart on the PC. The data structure is as follows:

{

Size of the message;
Application ID to which this message is to be sent (PC email client);
Function ID (or command ID) - Print Document;
Unique message ID;
// Function or Command specific data follows here
Document name and path
Description of print job (for example Email subject)
Printer to which document is to be printed
Printing job ID
Document location (PC/Handheld)
Print status
Printing options (duplex, landscape/portrait etc)
Flag to determine if document is to be deleted upon printing is done

}

Note that the document location can be either at the PC or handheld device—in this case of email, it will be the handheld device, but the point is that this command can also be used to print a document residing on the PC (with PC file browser on the Handheld).

After this printing message is received by the PC Email client, it determines the location of the document. If the document is residing on the handheld (which it is in this case of email), it reads the document from the handheld. Reading of the document is done by using the generic structure described above or by reading file API if any is provided by CMTL.

After the PC email client has the document to be printed, it queues the print job on the selected printer and with specified attributes (as specified in print structure). The Print job is queued using the printing API exposed by the OS.

After the print job is queued, the handheld Email client user has an option to check the status of the print job as follows.

Handheld to PC message:

{

Size of the message;
Application ID to which this message is to be sent (PC email client);
Function ID (or command ID) - Printer Jobs Enumeration;
Unique message ID;
// Function or Command specific data follows here
None

}
PC to Handheld message:
{

Size of the message;
Application ID to which this message is to be sent (PC email client);
Function ID (or command ID) - Printer Jobs Enumeration;
Unique message ID;
// Function or Command specific data follows here
List of print jobs with their status

}

In addition, the handheld user can set the default printer on the desktop remotely as follows.

Handheld to PC message:

{

Size of the message;
Application ID to which this message is to be sent (PC email client);
Function ID (or command ID) - Set Default Printer;
Unique message ID;
// Function or Command specific data follows here
Printer to be set as default

}

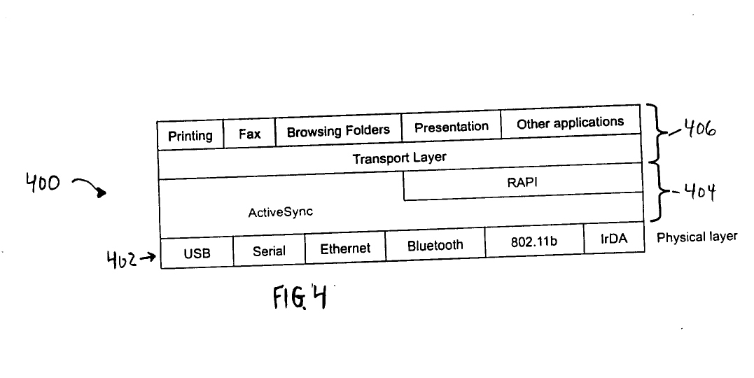

FIG. 4 shows one embodiment of a software architecture 400 for providing remote control of computer resources in accordance with the present invention. The architecture 400 is suitable for use in a handheld device and includes a physical layer 402 that provides interface capability to various interface technologies. For example, the physical layer 402 provides interfaces to USB, Bluetooth, 802.11b and other communication technologies. Virtually any communication technology can be interfaced to the device via the physical layer 202.

The architecture 400 also includes an operating system layer 404 that includes, for example, and ActiveSync component and a application interface (RAPI) component. Also included in the architecture 400 is a proprietary layer 406 that includes a transport layer for communicating between a handheld device and a personal computer. The layer 406 also includes applications that are used to allow a handheld device to control resources associated with a personal computer.

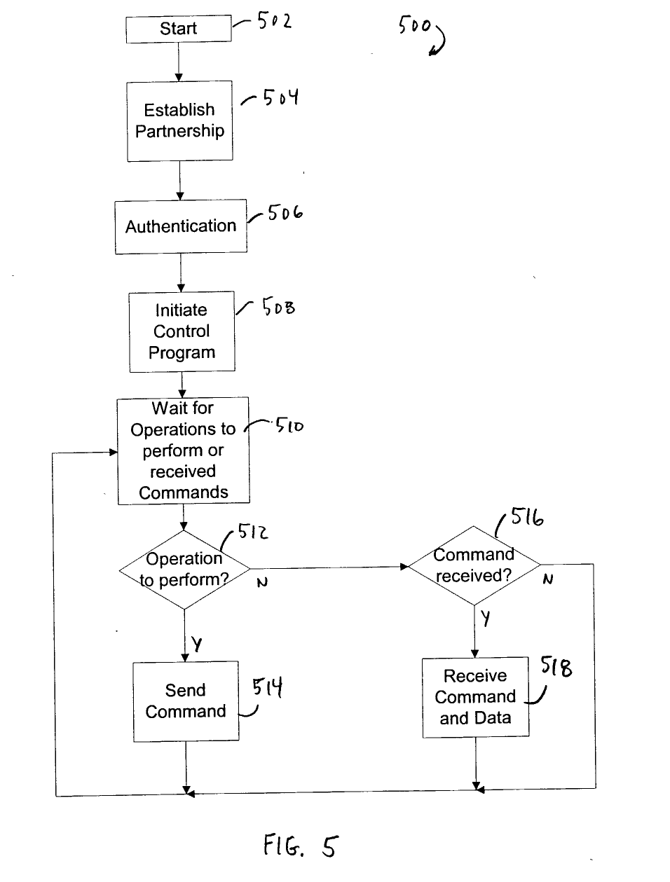

FIG. 5 shows a flow graph 500 illustrating the operation of one embodiment of the invention, where the invention is embodied operating on a handheld device, such as a PDA. At block 502, operation of the embodiment is started, for example, the handheld device is powered on.

At block 504, a partnership is established between the handheld device and a personal computer. For example, the personal computer may be a desktop or portable office or home computer. The partnership establishes a peer-to-peer network between the handheld device and the personal computer.

At block 506, an authentication process is performed. The authentication process allows the parties of the peer-to-peer network to authenticate each other. At block 508, after authentication is complete, the handheld device initiates a program to allow remote control of the personal computer's resources.

At block 510, the handheld device waits to receive input from the user regarding resources to be controlled. In the alternative, the handheld device waits to receive information or commands from the personal computer.

At block 512, a test is made to determine whether the handheld device has received any operations to perform. For example, the user may input a request to print a file on a printer accessible to the personal computer. If an operation is requested, the handheld device operates to send the appropriate commands to the personal computer as shown in block 514.

At block 516, a test is made to determine whether the handheld device has received any commands from the personal computer. For example, the personal computer may transmit data to the handheld device so that the data can be displayed on a display of the handheld device. If a command is received, the handheld device operates to receive and interpret the command as shown at block 518.

The program flow returns to block 510 after any operation or command is received, so that newly received operations or commands can be processed. Therefore, in accordance with the invention, the handheld device operates to control the resources of the personal computer. A description of the operation of the personal computer is provided below.

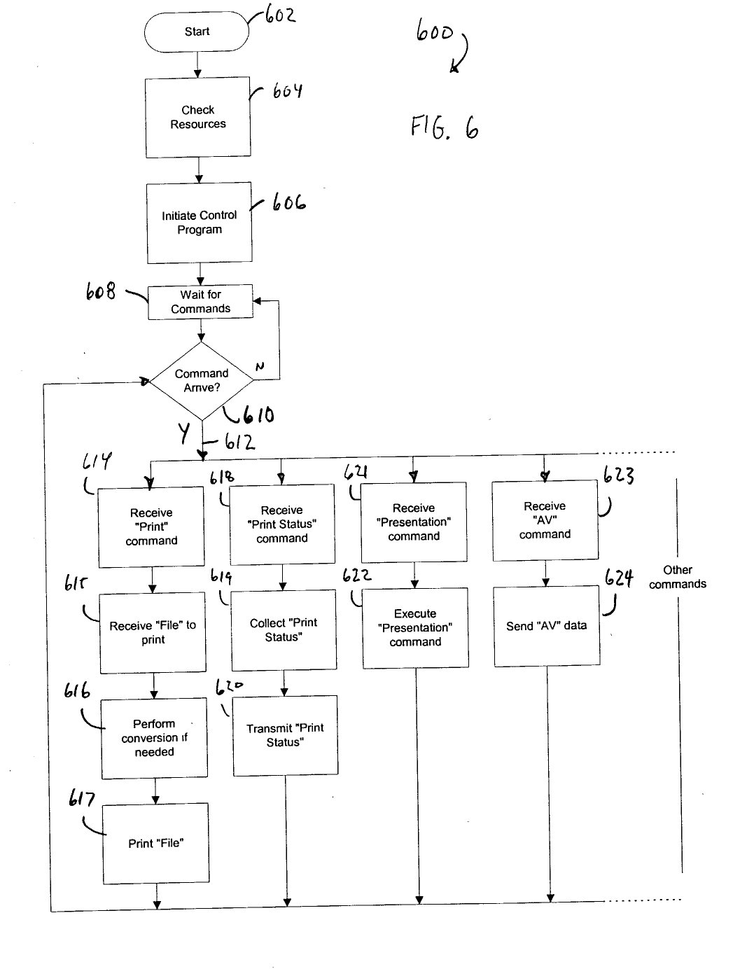

FIG. 6 shows a flow graph 600 illustrating the operation of one embodiment of the invention, where a portion of the invention is embodied operating on a personal computer, such as a desktop office computer. At block 602, operation of the embodiment is started, for example, the personal computer is powered on.

A block 604, the resources associated with the personal computer are checked. For example, the personal computer may have access to a local printer, a networked printer, remote storage or other resources. An exemplary list of resources is provided herein with reference to FIG. 8.

At block 606, a control program is initiated that begins looking for instructions from a remote handheld device. At block 608, the control program waits to receive commands from the remote handheld device.

At block 610, a test is made to determine if a command is received from the remote handheld device. If a command is not received, the program flows to block 608 to continue waiting for commands. If a command is received, the program flows down path 612 where a command interpretation process is conducted to allow remote control of a resource associated with the personal computer.

At blocks 614 through 617, a print command is received with an associated “File” from the handheld device. The personal computer may then convert the file if necessary, as shown at block 616. The file is then printed on a printer accessible to the personal computer as shown at 617. In a step not shown in FIG. 6, the user of the handheld device selects the printer, which will be used to print the file. For example, the user may select a printer local and directly connected to the personal computer, or a printer that is accessible to the personal computer via a network connection.

At block 618 through 620, a print status command is received and processed. For example, the user of the handheld device may send the print status command to the personal computer to determine the status of the file being printed. The personal computer responds by collecting the status and transmitting the results to the handheld device.

At block 621 through 622, a presentation command is received and processed by the personal computer. For example, the user of the handheld device may send commands that are directed to an application program running on the personal computer. For example, the personal computer may run a presentation program that displays presentation graphs on the display. The user of the handheld device may send control commands that control the operation of the presentation program. For example, selecting a graph for display may be controlled by the handheld device. In another operation, the handheld device may request the transmission of display screens so that these screen may be displayed on the handheld device. Virtually any operation performed by the personal computer can be performed by the remote handheld device.

At block 623 through 624, an audio/visual (AV) command is received from the handheld device and processed by the personal computer. For example, the AV command relates to video or audio functions that are available on the personal computer. In one example, the user of the handheld remote device may request video information be transmitted for display on the handheld device. In another example, audio information is transmitted for playback on the handheld device. Thus, in accordance with the present invention, a handheld device may remotely control resources (both physical and software resources) of a personal computer through a partnership communication channel.

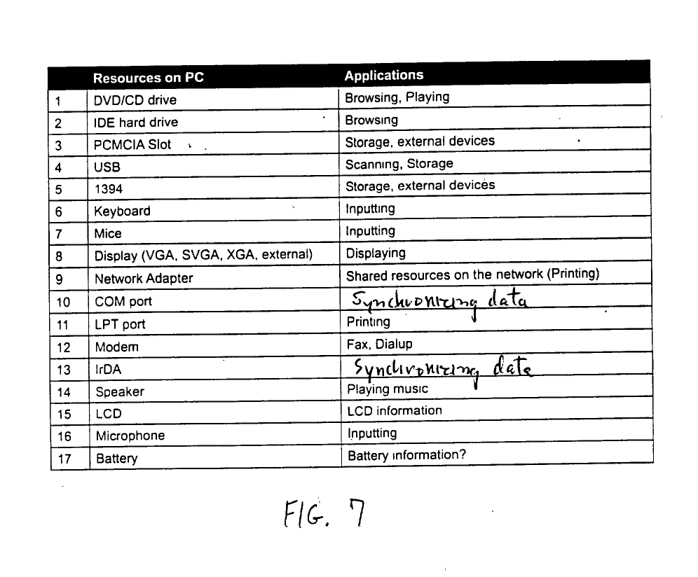

FIG. 7 shows an exemplary table of resources available on a PC and applications associated with those resources that may be remotely controlled by a handheld device in accordance with the present invention. For example, the PC's resources include a DVD, Display, Speaker, and LPT (printer) port. The applications include browsing, displaying, playing sounds, and printing. However, the table of FIG. 7 is exemplary and not limiting of the resources or applications that may be remotely controlled in accordance with the present invention.

The present invention includes a communication system for remotely controlling computer resources using a handheld device. The embodiments described above are illustrative of the present invention and are not intended to limit the scope of the invention to the particular embodiments described. Accordingly, while one or more embodiments of the invention have been illustrated and described, it will be appreciated that various changes can be made therein without departing from the spirit or essential characteristics thereof. Accordingly, the disclosures and descriptions herein are intended to be illustrative, but not limiting, of the scope of the invention, which is set forth in the following claims.

What is claimed is:

1. Method for using a handheld device having an embedded operating system to remotely control one or more resources associated with a personal computer, wherein the handheld device includes an interface to establish a communication channel with the personal computer, the method comprises:
establishing a partnership between the handheld device and the personal computer using the communication channel; and
sending a request from the handheld device to the personal computer using the communication channel, wherein the request is a request to control a selected resource associated with the personal computer.

2. The method of claim 1, wherein the communication channel comprises a hardwired connection.

3. The method of claim 1, wherein the communication channel comprises a wireless connection.

4. The method of claim 3, wherein the wireless connection comprises an 802.11b connection.

5. The method of claim 1, wherein the step of establishing a partnership is a step of establishing a partnership between the handheld device and the personal computer using ActiveSync technology.

6. The method of claim 5, wherein the step of sending is a step of sending a request from the handheld device to the personal computer using the communication channel, wherein the request is a request to control a printer that is directly connected to the personal computer.

7. The method of claim 6, wherein the step of sending is a step of sending a request from the handheld device to the personal computer using the communication channel, wherein the request is a request to control a printer that is accessible to the personal computer via a network connection.

8. The method of claim 1, wherein the step of sending is a step of sending a request from the handheld device to the personal computer using the communication channel, wherein the request is a request to control a selected application program associated with the personal computer.

9. The method of claim 8, further comprising a step of responding to the request by transmitting information from the selected application program to the handheld device using the communication channel.

10. A handheld device to provide remote control of computer resources associated with a personal computer, wherein the handheld device includes an interface to establish a communication channel with the personal computer, the handheld device comprising:
logic to establish a partnership between the handheld device and the personal computer using the communication channel; and
logic to send a request from the handheld device to the personal computer using the communication channel, wherein the request is a request to control a selected resource associated with the personal computer.

11. The handheld device of claim 10, wherein the communication channel comprises a hardwired connection.

12. The handheld device of claim 10, wherein the communication channel comprises a wireless connection.

13. The handheld device of claim 12, wherein the wireless connection comprises an 802.11b connection.

14. The handheld device of claim 10, wherein the logic to establish a partnership comprises logic to establish a partnership between the handheld device and the personal computer using ActiveSync technology.

15. The handheld device of claim 14, wherein the selected resource is a printer that is directly connected to the personal computer.

16. The handheld device of claim 15, wherein the selected resource is a printer that is accessible to the personal computer via a network connection.

17. The handheld device of claim 10, wherein the request is a request to control a selected application program associated with the personal computer.

18. The handheld device of claim 17, further comprising logic to respond to the request by transmitting information from the selected application program to the handheld device using the communication channel.

19. A personal computer device having associated computer resources, wherein the personal computer includes a communication channel with a handheld device that operates to control the computer resources, the personal computer comprising:
logic to establish a partnership between the handheld device and the personal computer using the communication channel; and
logic to receive a request from the handheld device using the communication channel, wherein the request is a request to control a selected computer resource associated with the personal computer.

20. The personal computer of claim 19, wherein the communication channel comprises a hardwired connection.

21. The personal computer of claim 19, wherein the communication channel comprises a wireless connection.

22. The personal computer of claim 21, wherein the wireless connection comprises an 802.11b connection.

23. The personal computer of claim 22, wherein the logic to establish a partnership comprises logic to establish a partnership between the handheld device and the personal computer using ActiveSync technology.

24. The personal computer of claim 23, wherein the selected resource is a printer that is directly connected to the personal computer.

25. The personal computer of claim 24, wherein the selected resource is a printer that is accessible to the personal computer via a network connection.

26. The personal computer of claim 19, wherein the request is a request to control a selected application program associated with the personal computer.

27. The personal computer of claim 26, further comprising logic to respond to the request by transmitting information from the selected application program to the handheld device using the communication channel.

28. A computer software product that includes a medium readable by a processor in a handheld device, the medium having stored thereon:
a first sequence of instructions which, when executed by said processor, causes said handheld device to establish a partnership between the handheld device and a personal computer using a communication channel; and
a second sequence of instructions which, when executed by said processor, causes said handheld device to send a request to the personal computer using the communication channel, wherein the request is a request to control a selected resource associated with the personal computer.

29. A computer-readable medium of instructions, comprising:
means for establishing a partnership between a handheld device and a personal computer using a communication channel; and
means for sending a request from the handheld device to the personal computer using the communication channel, wherein the request is a request to control a selected resource associated with the personal computer.

30. A computer data signal embodied in a carrier wave comprising;
a first source code segment comprising one or more sequences of instructions, which when executed by a processor included in a handheld device, causes said handheld device to establish a partnership between the handheld device and a personal computer using a communication channel; and
a second source code segment comprising one or more sequences of instructions, which when executed by the processor included in the handheld device, causes said handheld device to send a request to the personal computer using the communication channel, wherein the request is a request to control a selected resource associated with the personal computer.
